(19) United States
(12) Patent Application Publication
(10) Pub. No.: US 2023/0359963 A1
(43) Pub. Date: Nov. 9, 2023

(54) VALIDATION OF COST-OPTIMAL MINIMUM TURN TIMES

(71) Applicant: The Boeing Company, Chicago, IL (US)

(72) Inventors: Oleksandr Basanets, Lasalle, IL (US); Dhruv R. Sharma, Montreal, CA (US)

(73) Assignee: The Boeing Company, Chicago, IL (US)

(21) Appl. No.: 17/662,091

(22) Filed: May 5, 2022

(51) Int. Cl. G06Q 10/06; G08G 5/00

(52) U.S. Cl. CPC G06Q 10/06312; G06Q 10/06393; G06Q 10/063118; G08G 5/003

(57) ABSTRACT

A computer-implemented method for determining a cost-optimal minimum turn time of a subject vehicle at a station includes receiving historical data via a processor, including actual past turn times and available turn times of the subject vehicle at the station. The method also includes creating a two-dimensional (2D) scatter plot of the historical data from a plurality of data points, identifying an inflection point on the 2D scatter plot as a point of intersection of two straight lines, and determining the cost-optimal minimum turn time using the inflection point. A scheduling action of the subject vehicle is executed via the processor using the cost-optimal minimum turn time. A system for performing the method includes the processor, a database of the actual past turn times and available turn times, and instructions recorded in memory. Execution of the instructions causes the processor to perform the method.

### BACKGROUND

The present disclosure pertains to operational scheduling systems and underlying methodologies for determining realistic and reliable turnaround time durations (“turn times”) of passenger aircraft, trains, automobiles, and other transport vehicles of the types used in the performance of commercial vehicle operations.

Commercial vehicle operations require the careful coordination of a wide array of processes, including loading and unloading of passengers and cargo, refueling, cleaning, and maintenance. This is particularly true in airports, train stations, bus stations, loading docks, rental car facilities, and other busy transportation hubs. It is desirable to minimize turn time, i.e., the amount of time a given vehicle is idle at one of the above-noted transportation hubs as while awaiting completion of one or more of the exemplary tasks noted above. To that end, automated scheduling operations are often used to estimate turn times and communicate the same to operators, passengers, and delivery customers. However, estimated turn times for a given vehicle, vehicle type, or transportation hub can be inaccurate relative to actual experienced turn times on a given day of operations, which in turn produces unexpected delays and associated costs.

### SUMMARY

The subject disclosure enables the automated validation of minimum turn times and selective adjustment of existing transportation schedules. The disclosed methodology for automatically detecting and evaluating minimum turn times relies on statistical processes to ascertain relevant data. Final results are then presented in a visual and comprehensive manner for ultimate consumption by a host of end users, including but not limited to vehicle crews, passengers, schedulers, and maintenance personnel.

Exemplary embodiments described herein pertain to commercial airport operations and related scheduling of passenger and/or cargo aircraft. However, those skilled in the art will appreciate that the present teachings may similarly benefit operations of other vehicles such as automobiles, trains, and boats, and therefore the various representative airport/aircraft use scenarios described herein are intended to be illustrative of the present solutions and non-limiting thereof.

Aircraft scheduling in general requires the construction of an optimal and compliant sequence of flights, often across multiple flight legs. For example, a flight from airport A to airport C could require a stopover at airport B, in which case the flight is broken into flight legs A-B and B-C. Extended turn times experienced at airports A or B would therefore impact downstream day-of-operations at airport C in this simplified example scenario. Optimality criteria for a sequence of flights can be evaluated against an associated cost, with the cost varying based on how closely together the sequential flights could possibly be placed without adversely affecting operations.

“Cheaper” in the context of minimizing the associated costs as contemplated herein thus means “minimizing turn times”. However, constraints—often unknown beforehand—do not allow sequential flight legs to be scheduled too closely together. For instance, an aircraft manufacturer might recommend a theoretical minimum turn time for a given aircraft type, e.g., a small regional transport aircraft typically requires less time to refuel and clean than a multi-engine jumbo jet. Unlike such planned costs, however, actual turn times on a given day of operations depend on a combination of other factors, such as the particular station/airport, day of week, time of day, route, aircraft type, aircraft family, etc. It is therefore not always possible to accurately calculate minimum turn times ahead of time. To that end, the present strategy provides an automated/computer-executable solution for determining and validating aircraft minimum turn times, and more accurately re-timing ongoing flight operations, including flight scheduling, aircrew pairing, maintenance, and other possible operations.

In particular, a method for determining a cost-optimal minimum turn time of a subject vehicle at a station includes receiving historical data via a processor. The historical data includes a set of actual past turn times of the subject vehicle at the station and available turn times of the subject vehicle at the station. Additionally, the method includes creating a two-dimensional (2D) scatter plot of the historical data via the processor, with the 2D scatter plot having a plurality of data points, and then identifying an inflection point on the 2D scatter plot as a point of intersection of two straight lines on the 2D scatter plot. The method includes determining the cost-optimal minimum turn time via the processor using the inflection point, and then executing a scheduling action of the subject vehicle via the processor using the cost-optimal minimum turn time.

In an aspect of the disclosure, the method includes performing a Hough transform on the plurality of data points via the processor to thereby derive the two straight lines. Alternatively, the method may include deriving the two straight lines using an iterative procedure, including applying a predetermined static slope parameter and a dynamic intercept parameter.

The predetermined static slope parameter is 0.41 in a possible embodiment.

Executing the scheduling action of the subject vehicle may include displaying the cost-optimal minimum turn time on a heatmap chart, with the heatmap chart including a color-coded background indicative of a relative difference between the cost-optimal minimum turn time and an expected minimum turn time provided by a manufacturer of the subject vehicle.

The subject vehicle is an aircraft in a possible embodiment, in which case the station may be an airport or a terminal of the airport.

Executing the control action using the cost-optimal minimum turn time optionally includes modeling flight delay propagation through a plurality of airports. In turn, modeling the flight delay propagation through the plurality of airports may include performing a Gumbel approximation.

Executing the scheduling action may optionally include using the cost-optimal minimum turn time to determine a future impact on a predicted reliability level of the expected minimum turn time, or rescheduling a departure of the subject vehicle from the station.

Also disclosed herein is a scheduling system having a processor, a database, and instructions. The database includes recorded historical data, including a set of actual turn times of a subject vehicle at a station and available turn times of the subject vehicle at the station. The instructions are configured for determining a cost-optimal minimum turn time of the subject vehicle at the station. Execution of the instructions by the processor causes the processor to receive, extract, or otherwise retrieve the historical data from the database, create a 2D scatter plot of the historical data, with the 2D scatter plot having a plurality of data points, and identify an inflection point on the 2D scatter plot as a point of intersection of two straight lines thereon. Execution of the instructions also causes the processor to determine the cost-optimal minimum turn time using the inflection point, as well as execute a scheduling action of the subject vehicle using the cost-optimal minimum turn time.

In another aspect of the disclosure, a method for determining a cost-optimal minimum turn time of an aircraft at an airport includes receiving historical data via a processor, the historical data including a set of actual turn times at the airport and available turn times at the airport. The method in this embodiment also includes creating a 2D scatter plot of the historical data via the processor, with the 2D scatter plot being comprised of a plurality of data points. The method also includes identifying an inflection point on the 2D scatter plot as a point of intersection of two straight lines thereon, including deriving the two straight lines using an iterative procedure by applying a static slope parameter of 0.41 and a dynamic, i.e., variable, intercept parameter. Additionally, the method includes determining the cost-optimal minimum turn time via the processor using the inflection point, and also executing a scheduling action of the aircraft using the cost-optimal minimum turn time, including rescheduling a departure of the aircraft based on the cost-optimal minimum turn time.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 illustrates a representative commercial aircraft whose turn time is validated in accordance with the present approach.

FIG. 1A depicts a system configured to perform the method as set forth herein.

FIG. 2 is an exemplary plot of aircraft turn time and associated combined costs.

FIG. 3 is a flow chart describing an embodiment of a method for validating minimum turn times of the aircraft of FIG. 1.

FIG. 4 is a plot of available turn times vs. actual turn times as determined via the present method.

FIG. 4A is a table illustrating an example set of available and actual turn times.

FIG. 5A is a plot of intersecting lines used to find an inflection point as part of the described methodology.

FIGS. 5, 6, and 7 are three-dimensional plots of an exemplary Hough transformation used in accordance with an embodiment of the disclosure.

FIGS. 6A and 7A are representative two-dimensional scatter plots of available vs. actual turn times illustrating an implementation of the method of FIG. 2.

FIGS. 8 and 9 are two-dimensional scatter plots of available vs. actual turn times illustrating a zone of inflection in accordance with an embodiment of the disclosure.

FIGS. 10 and 11 are tables showing possible graphical presentations of results derived using the method of FIG. 3.

FIG. 12 is a histogram of an exemplary Gumbel approximation in accordance with an aspect of the disclosure.

The present disclosure is susceptible to modifications and alternative forms, with representative embodiments shown by way of example in the drawings and described in detail below. Inventive aspects of this disclosure are not limited to the disclosed embodiments. Rather, the present disclosure is intended to cover alternatives falling within the scope of the disclosure as defined by the appended claims.

### DETAILED DESCRIPTION

Embodiments of the present disclosure are described herein. It is to be understood, however, that the disclosed embodiments are merely examples, and that other embodiments can take various and alternative forms. The Figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

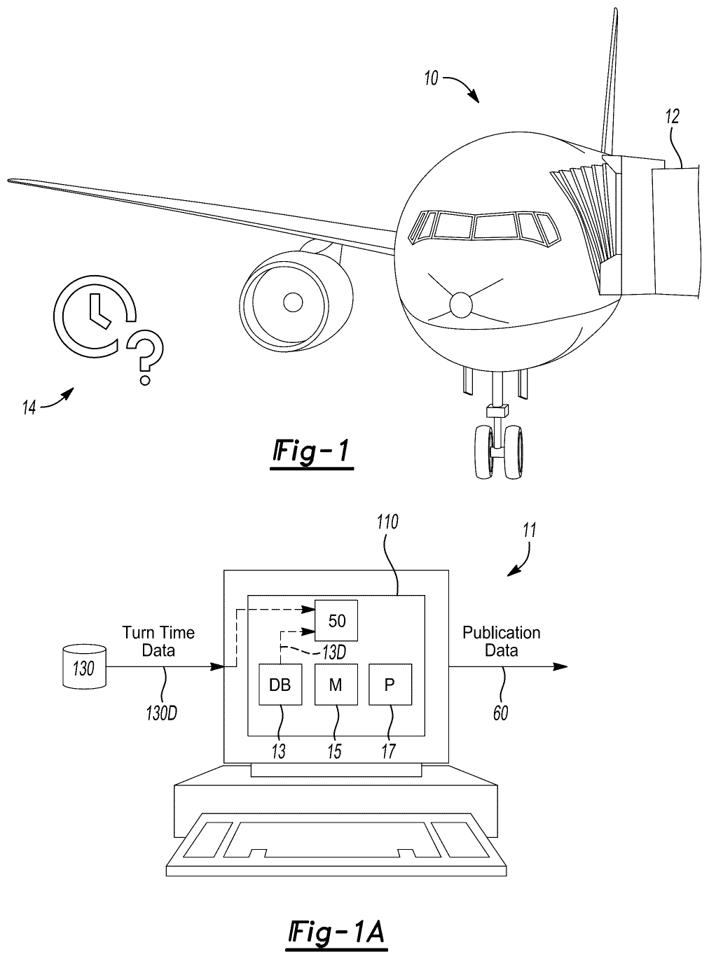

Referring to the drawings, wherein like reference numbers refer to the same or like components in the several Figures, a representative vehicle 10 in the form of an aircraft is shown in FIG. 1. While the present teachings can be extended to various other vehicles 10 as noted above, the vehicle 10 will be described hereinafter as being an airplane, helicopter, or another aircraft, with the vehicle 10 thus referred to as an aircraft 10 for illustrative simplicity and clarity.

The aircraft 10 is parked at a station 12, which in the illustrated embodiment of FIG. 1 is a gate of an airport terminal. Various operational tasks are performed while the aircraft 10 remains parked at the station 12, such as but not limited to cleaning, refueling, loading and unloading of passengers and cargo, maintenance, and crew changes. The elapsed time duration from the moment the aircraft 10 arrives at the station 12 until the moment the aircraft 10 pulls away from the station 12 is referred to below and in the general art as turnaround time or “turn time”.

From the perspective of aircrews, ground crews, passengers, and customers, it is desirable to minimize turn time. However, the performance of the myriad of different tasks at the station 12 requires at least a minimum amount of turn time. This minimum turn time is impacted by a host of factors, some of which are fixed/predetermined and others of which will vary with the particular location of station 12, as well as the date, time of day/week/month/year, type of aircraft 10, etc. As a result, it is often difficult to accurately predict turn times on a given day of operations. This uncertainty, represented in FIG. 1 by symbol 14, results in unreliability of generated flight schedules, which in turn leads to elevated operating and opportunity costs, passenger dissatisfaction, crew fatigue, and other potential problems. The present solutions are therefore intended to address these and other potential problems, thereby improving upon the current state of the art of flight scheduling and related systems.

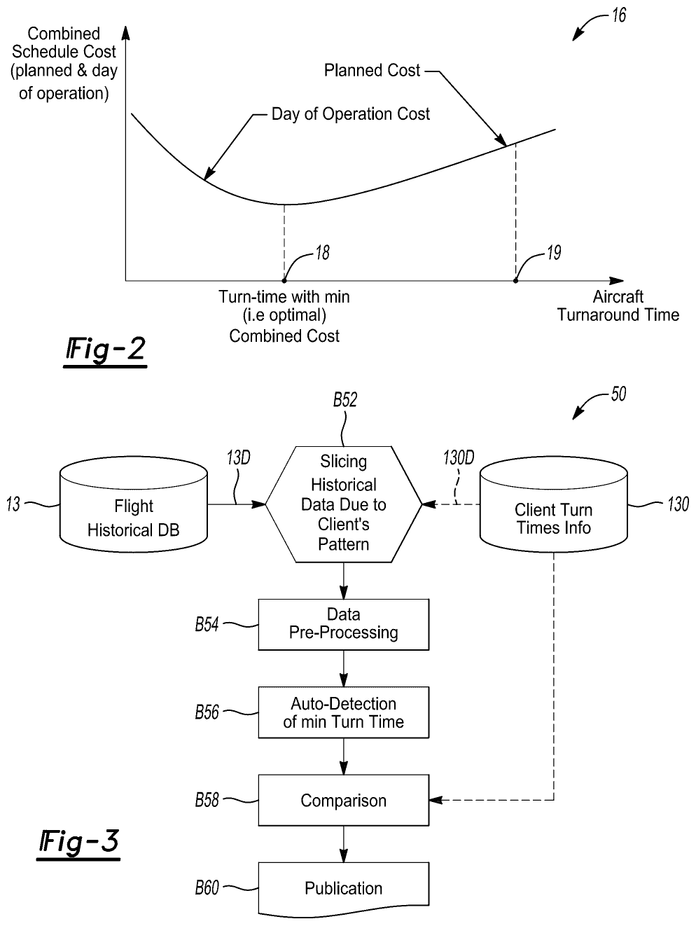

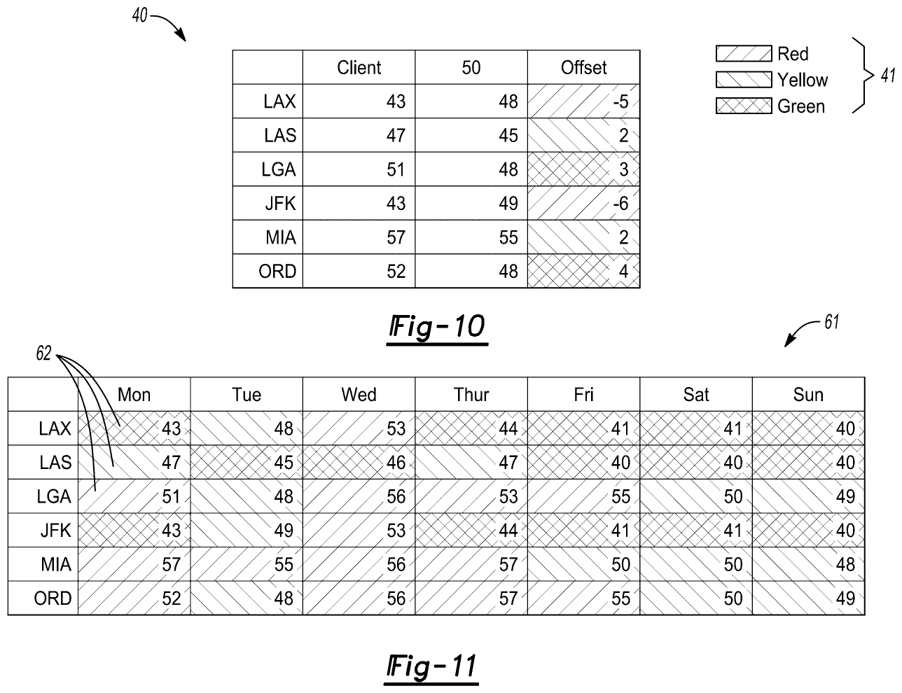

Referring briefly to FIG. 1A, such a scheduling system 11 may include a flight historical database (DB) 13, memory (M) 15, and one or more processors (P) 17, e.g., application-specific integrated circuits, microprocessors, or processing cores. Although omitted from the Figures for illustrative simplicity, the scheduling system 11 may include other hardware and software elements, such as but not limited to input/output (I/O) devices, graphics boards, filters, and the like. Memory 15 for its part may include application suitable amounts of random access memory (RAM), read only memory (ROM), flash memory or other solid-state memory, etc. Together, these and other possible hardware components execute instructions embodying a method 50, an example of which is depicted in FIG. 3 and described below. To that end, the database 13 includes recorded flight historical data 13D, including a set of actual turn times of the aircraft 10 or other subject vehicle at the station 12. The flight historical database 13 and/or an external client database 130 also includes available turn times 130D of the aircraft 10 at the station 12, e.g., as predetermined turn times for a given aircraft 10, station 12, etc. The instructions for determining a cost-optimal minimum turn time of the aircraft 10 at the station 12 are recorded in memory 15. Execution of the instructions by the processor 17 causes the processor 17 to execute the present method 50, with the processor 17 ultimately outputting publication data 60 for consumption by a variety of end users, with the publication data 60 in some embodiments being displayable via a display screen 110 of the system 11 as described below with particular reference to FIGS. 10-12.

Referring to FIG. 2, a representative cost curve 16 illustrates the above-noted costs in terms of Combined Schedule Cost, i.e., “Planned Cost” and “Day of Operation Cost”. At the original (point O), of the cost curve 16, the day of operation costs are at a relative high, indicating that scheduled turn times are too short. Similarly, the costs increase out at time point 19, indicating that turn times are too long. Somewhere along the span of the cost curve 16, a point exists, in this case optimal point 18, at which costs associated with turn time are minimized, and thus “optimal” for the purposes of the present disclosure. The present strategy seeks to find the optimal point 18 and thereafter use its corresponding value to improve upon the functionality existing scheduling systems, with a variety of beneficial uses and hardware/process improvements detailed below.

FIG. 3 depicts an embodiment of the method 50 for determining an optimal minimum turn time of a subject vehicle at a station, e.g., the representative aircraft 10 and station 12 shown in FIG. 1. When used in the exemplary context of air travel, the method 50 can be summarized into constituent process steps or “blocks” as shown, with applications of the method 50 enabling the automatic assessment, validation, and visualization of minimum turn time. The method 50 of FIG. 3 can also be used to improve scheduling of crew pairing and aircraft routing, validate flight re-timing process results, and simplify stochastic modeling of aircraft ground operation processes in Monte-Carlo simulations, as will be appreciated by those skilled in the art in view of the following disclosure, and as described in greater detail below.

Block B52 (“Slicing Historical Data Due to Client's Pattern”) of the method 50 includes receiving flight historical data 13D via the processor 17 of FIG. 1A, or using another suitable computer device. As contemplated herein, such flight historical data 13D may include a set of actual turn times at the particular station 12 under consideration and available turn times at the station 12. Such information may be recorded over time in the flight historical database 13, in which case block B52 includes accessing the flight historical database 13 and extracting the relevant flight historical data 13D therefrom.

Block B52 may also include receiving client turn time information, e.g, from a client database 130 (“Client Turn Times Info”), e.g., as predetermined turn time data from a manufacturer of the aircraft 10 shown in FIG. 1. By way of an illustrative example, two different aircraft 10 of nominal types I and II may have expected turn times of 40-minutes and 55-minutes, respectively, with the particular turn times at a given station 12 having a corresponding pattern or characteristic range. Block B52 therefore includes the above-noted processor 17 of FIG. 1A being informed of actual (past) and expected (future) turn times, with the latter, absent the present solutions, being largely a ballpark estimate based on past experience across a fleet of the aircraft 10. The method 50 then proceeds to slice or divide the flight historical data 13D into relevant time increments based on the client's provided pattern. The method 50 then proceeds to block B54.

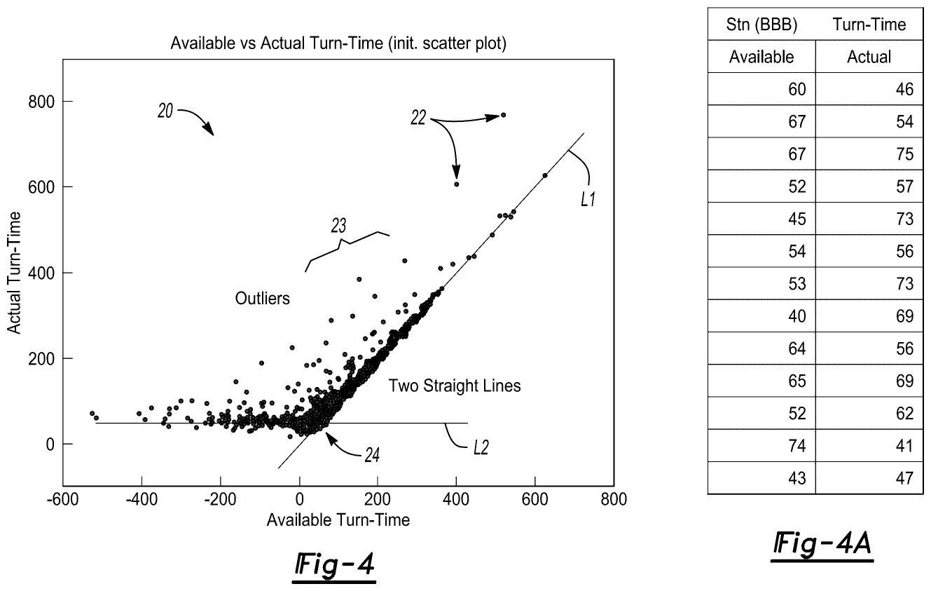

At block B54 (“Data Pre-Processing”), and referring also to FIG. 4, the method 50 of FIG. 3 includes creating a two-dimensional (2D) scatter plot 20 from the flight historical data 13D from block B54, and automatically calculating a dynamic intercept parameter from the slope-intercept form of a cutoff line to apply to the 2D scatter plot 20. The 2D scatter plot 20, which is comprised of a plurality of discrete data points 22, some of which are statistical outliers as shown generally at 23, is ultimately transformed into intersecting lines L1 and L2. The 2D scatter plot 20 has an inflection point 24 that may be difficult to ascertain. However, the point at which lines L1 and L2 intersect corresponds to the inflection point 24, and thus the inflection point 24 is determined as part of the method 50 to accurately identify the optimal turn time.

A representative subset of baseline data corresponding to the data points 22 of FIG. 4 is shown in FIG. 4A. Such information may be collected over time at each station 12 and retained for consumption by the present method 50. The specific values of FIG. 4A are illustrative of the present teachings and thus non-limiting. However, the values collectively show that a non-trivial variance often exists between an available turn time at a given station 12 and the actual turn time spent or required at the same station 12. For instance, while a data pair (60, 46) in FIG. 4A would indicate that a longer turn time is available at a particular station 12 than is actually needed, another data pair (54, 56) would indicate the opposite situation, i.e., that the aircraft 10 would require more turn\ time than the station 12 permits. The method 50 of FIG. 3 thus proceeds to block B56 when the 2D scatter plot 20 of FIG. 4 has been generated.

At block B56 (“Auto-Detection of Min Turn Time”) of FIG. 3, the 2D scatter plot 20 shown in representative form in FIG. 4 is reduced to the aforementioned imaginary straight lines L1 and L2 This occurs within the scope of the method 50 using one of the predetermined statistical processes described below or another suitable alternative thereof. Block B56 also includes identifying the inflection point 24 on the 2D scatterplot 20 as the point of intersection of the two straight lines L1 and L2 thereon. As appreciated in the art, calculation of the coordinates of intersection of two straight lines is a common task in image processing and recognition. To find the coordinates of intersection, for instance, one may use the solutions disclosed in U.S. patent application Ser. No. 15/458,749, titled “Turn Time Analytics”, which was filed on Mar. 14, 2017, and which is hereby incorporated by reference in its entirety.

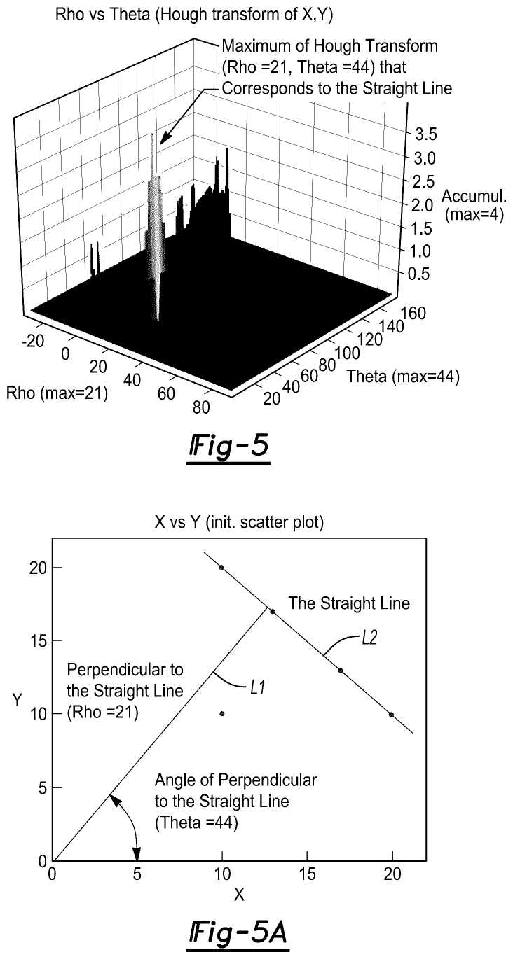

To be able to employ the present teachings, one must first reduce the 2D scatter plot 20 to the two straight lines L1 and L2. Two approaches are contemplated herein based on the density and volume of the underlying data: (1) a Hough transform, and (2) an iterative procedure, an example of which is referred to below as Automatic Inflection Point Detection. While approach (1) has utility in some situations, for instance when scheduling flights in small airports with low traffic, the Hough transform may be impracticable when used for higher volume analysis, such as busy commercial airports. In such cases, block B56 could rely instead on approach (2). Both approaches will now be explained in detail with reference to FIGS. 5-9.

HOUGH TRANSFORM: one approach to performing block B56 of FIG. 3 is to perform a Hough transform on the plurality of data points 22 via the processor 17 of FIG. 1A to thereby derive the two straight lines L1 and L2. As noted above, the inflection point 24 being sought is defined as the geometrical intersection of the two straight lines L1 and L2 represented in FIG. 4. Referring to FIGS. 5 and 5A, the Hough transform involves converting each data point 22 from the original 2D scatter plot 20 into two-parameter space, i.e., Rho and Theta. Here, parameter “Rho” represents the distance from the origin (O) to the line perpendicular to the desired straight line. Parameter “Theta” represents the angle of the perpendicular projection from the origin to the line measured in degrees from the positive x-axis. After converting each data point 22 into the two-parameter space, the system 11 of FIG. 1A can automatically detect the local maximum corresponding to the two original straight lines L1 and L2 of FIG. 5A, with the maximum best shown in FIG. 5.

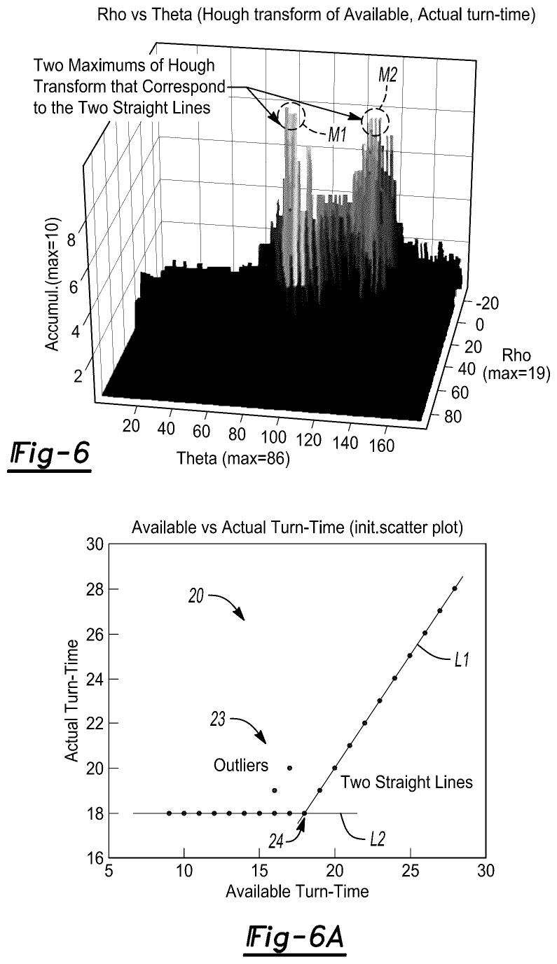

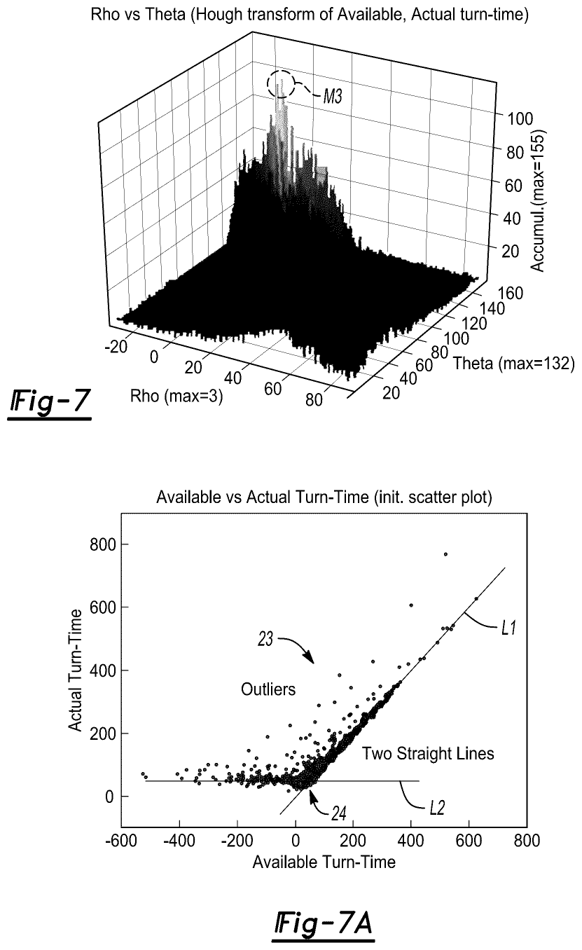

As indicated above, reliance on the Hough transform provides good results when the initial 2D scatter plot 20 contains relatively few data points 22. Such a scenario is represented in FIGS. 6 and 6A. As shown in FIG. 6, two maximums M1 and M2 of the Hough transform are found that correspond to the two straight lines L1 and L2 of FIG. 6A. However, problems can arise with too many data points 22 as depicted in FIGS. 7 and 7A, e.g., with a large number of flights in a busy airport. In such a scenario, it may be difficult to identify the two maximums that correspond to the original projects straight lines L1 and L2. Such maximums reside somewhere in region M3 in FIG. 7, but are not readily distinguishable relative to the result of FIG. 6. Therefore, the Hough transform may be selectively used where appropriate, with block B56 otherwise relying on approach (2), i.e., automatic inflection point detection.

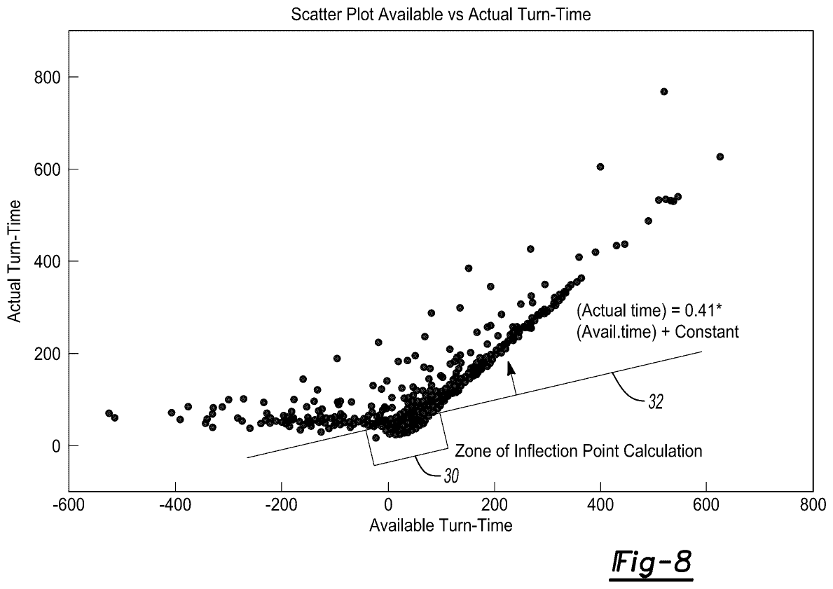

AUTOMATIC INFLECTION POINT DETECTION: referring to FIG. 8, this alternative approach to deriving the two straight lines uses an iterative procedure, including applying a predetermined static slope parameter and a dynamic/variable intercept parameter, using the familiar y=mx+b formulation. By way of an example, a cutoff line 32 has a static/unchanging slope parameter in the form of predetermined slope coefficient, i.e., m, which is 0.41 in an embodiment of the described approach. Using this variation in the performance of block B56, the inflection point 24 is determined in a simple, iterative, and fully automatic manner. This approach is used to effectively search a zone of inflection 30 within which the actual inflection point (not shown) is to be found.

In particular, (i) for an initial value of a slope parameter, e.g., ten (10), the slope-intercept form for the cutoff line 32 is defined as follows:

Actual_time=0.41*Avail._time+10

Then, the processor 17 of FIG. 1A calculates the number of data points 22 on the scatter plot 20 that fulfill the condition:

Actual_time<0.41*Avail._time+10.

Next, (ii) if the number of data points 22 fulfilling this condition is sufficiently large, e.g., >100 or another suitable count, then the method 50 of FIG. 3 proceeds by calculating the median value of “Avail._time” for those qualifying data points 22. The calculated median value represents the required minimum turn time for that particular combination of parameters, e.g., station 12, type of aircraft 10, day of the week, time of day, route, etc.

Once the above-described processes (i) and (ii) have been completed, the method 50 of FIG. 3 proceeds to (iii) determine if the number of data points 22 that fulfill the above condition is less than the predetermined number, e.g., <100 in keeping with the above non-limiting example. If so, the method 50 proceeds by increasing the value of the aforementioned constant value, for instance by increasing the constant value from ten (10) to twenty (20). Using such representative values, therefore, the new cutoff line will be defined as:

Actual_time=0.41*Avail._time+20.

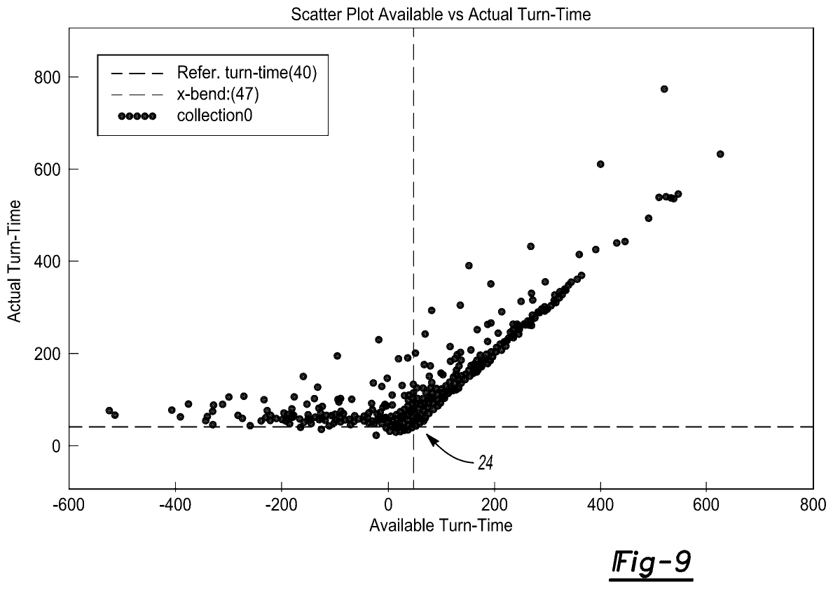

The results obtained using this automatic inflection point detection approach are represented in FIG. 9, which shows the coordinates of the inflection point 24. Thus, either of the two described strategies could be used for detecting the optimal minimum turn time using the inflection point 24.

Referring once again to FIG. 3, block B58 (“Comparison”) includes comparing the results to the expected results from the client, e.g., as recorded in the external client database 130. An aircraft's minimum turn time as obtained by the above described method 50 may at times vary, sometimes significantly, from values provided by clients, such as a manufacturer of the aircraft 10 of FIG. 1. For instance, a seemingly minor difference of seven minutes between a client-provided turn time and one determined via the method 50 can translate to substantial cost savings on the actual day of operation, and likewise can reduce the risk of disruption to flight operations.

An illustrative example of this is shown in table 40 of FIG. 10, which is one possible embodiment of the above-described publication data 60 shown schematically in FIG. 1A. Table 40 compares client-provided estimated turn times (“Client”) with results generated using the above-described method 50. Column “Offset” may be color-coded, e.g., using the GREEN, YELLOW, and RED colors of a corresponding color key 41 as incorporated into traffic lights, or another suitable color scheme to indicate relative results. That is, a RED result may be determined when the method 50 indicates substantially longer turn times relative to the client-provided values, and a GREEN result may be determined when the opposite situation arises. In between these extremes, a YELLOW result may be used to represent that the difference is present, albeit at a lesser amount. The method 50 proceeds to block B60 once the results of the comparison of block B58 are complete.

Block B60 (“Publication”) of FIG. 3 includes executing a scheduling action of the aircraft 10 shown in FIG. 1 or another subject vehicle using the optimal minimum turn time as determined in block B56. Referring briefly to FIG. 11, one possible performance of block B60 includes executing the scheduling action of the aircraft 10 of FIG. 1 using the optimal minimum turn time by displaying the optimal minimum turn time on a heatmap chart 61. The heatmap chart 61 as contemplated herein includes a color-coded background 62, which is depicted graphically in FIG. 11 as patterned backgrounds identified in color key 41. The number and identity of the various assigned colors may vary with the application, with the three colors used in the simplified example implementation of FIG. 11 being illustrative of the present teachings and non-limiting thereof.

Each color used in the heatmap chart 61 is indicative of a relative difference between the optimal minimum turn time as determined by the method 50 and an expected minimum turn time. In the illustrated heatmap chart 61, for instance, multiple representative airports (LAX, LAS, LGA, JFK, MIA, ORD) are shown for a given week (Mon-Sun). Rather than depicting the client and method 50-based “offsets” as shown in FIG. 10, however, the heatmap chart 61 may display the optimal minimum turn time, numerically, against the color-coded background 62. Thus, a user could perceive at a glance that a given station 12 is running ahead or behind its expected minimum turn time.

In some implementations, the various airports could be clicked on to open another heatmap chart 61, such as one depicting the various gates or flight numbers, thereby providing additional levels of granularity to the results. In this manner the results may be presented in a way that would facilitate the user's comprehension of the information. Additionally, the depicted information may be used to recommend reductions or extensions in expected minimum turn times, e.g., if the results predicted by the method 50 routinely show that the expected minimum turn times provided by the manufacturer are inaccurate. Thus, by extension the process of executing the scheduling actions can include using the optimal minimum turn time from method 50 to forecast an impact on a reliability level of the expected minimum turn time, thereby enabling one to foresee the impact of rescheduling on an actual day of operations. For example, one may reschedule a flight leg with the expectation that the impact of the rescheduling is minimal, with the method 50 determining ahead of time that the actual impact would be far greater. As a consequence, a scheduling system used with or as part of the system 11 of FIG. 1A may choose to reduce the amount of rescheduling to minimize the downstream impact. Thus, one is able to make sure that after the “earlier rescheduling”, the resulting schedule is still within the safe minimum turn time specified by the manufacturer, i.e., will not create additional problems on the actual day of operations. In this way the present teachings increase the schedule reliability.

Referring once again to the method 50 exemplified in FIG. 3, the control action of block B60 in some applications may include using the optimal minimum turn time to model flight delay propagation through a plurality of airports. That is, for a representative flight from airport A to airport B, unexpectedly rapid or slow turnarounds at airport A would impact scheduling at airport B, and so on down the line. Therefore, rather than operating as a stand alone system in a given airport, in this instance airport A, the results of each airport in a network of airports could be shared to account for such unexpected rapid or slow turns.

For instance, airports often use modeling software to model flight delay propagation through multiple different airports, e.g., using a Monte Carlo simulation with twelve discrete events, typically positioning and removing passenger bridges or stairs, deplaning and boarding passengers, cargo loading and unloading, fueling, cleaning, etc. The present approach could reduce the number of discrete events to just the two turn time distributions in the “left zone” and “right zone” of the inflection point 24, i.e., where t<inflection point 24, and where t≥inflection point 24, respectively.

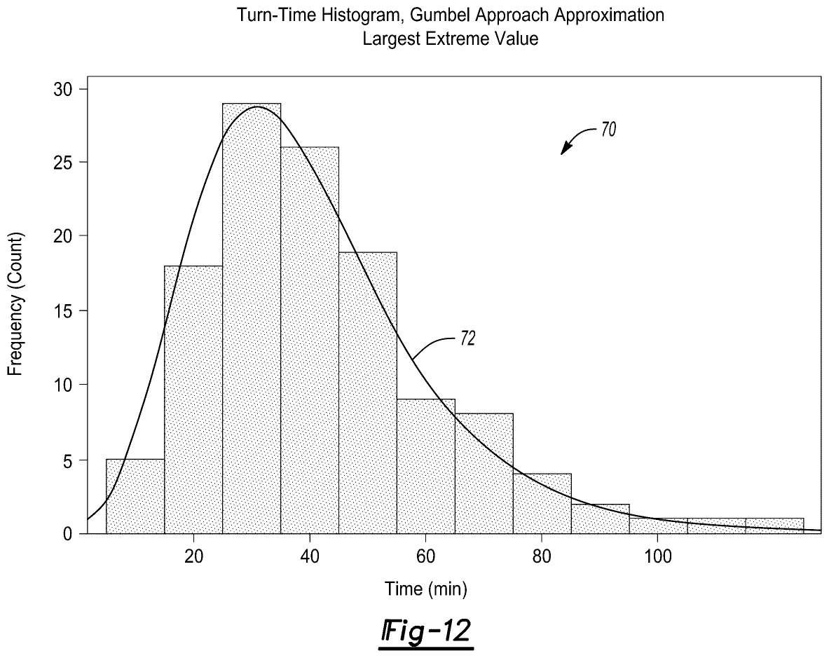

Referring briefly to FIG. 12, a histogram 70 with an overlaid curve 72 provides a Gumbel approximation usable in an aspect of the disclosure. To represent the ground time operation in a Monte-Carlo stochastic simulation, one can reduce the number of stochastically-modeled processes from the above-noted twelve events down to just the two noted above, with the two processes being described statistically by five parameters: (μ1, β1), the inflection point 24, and (μ2, β2), where μ is a mode of distribution, β is a scale parameter, μ+β is a mean of distribution, and y is the Euler-Mascheroni constant, i.e., 0.577 . . . , as appreciated in the art:

$$f ( t ) = \frac{1}{β} {e}^{\frac{t - μ}{β}} {e}^{- {e}^{\frac{t - μ}{β}}}$$

The largest extreme value, is thus locatable in a simplified manner to speed up ground operations modeling in a Monte-Carlo simulation.

Alternatively or concurrently, executing the scheduling action(s) using the optimal minimum turn time could include scheduling an earlier departure of the aircraft 10 of FIG. 1 to account for predetermined crew operating time limits, or scheduling crew replacements or substitutions in the event rescheduling of the flights is not possible. As appreciated in the art, an aircraft 10 is not profitable when it sits idle. However, human crews are also not permitted to fly for longer than a specified duration set by relevant national or regional standards. Based on the results of the method 50 the same aircrew may be able to take off sooner than expected. For instance, if an aircrew is permitted to fly for eight hours in a given day, and the expected turn time is too long, thus requiring a crew change, the results of method 50 may show that the aircraft 10 could take off a bit earlier, thus making a crew change unnecessary. Re-timing processes of this type may entail moving some flight legs to accommodate crew flying time or other constraints, while dynamically defining a permissible range for moving a given flying leg.

The present teachings as set forth in detail above are thus intended to provide a minimum turn time evaluation system and corresponding computer-based methodology. As noted above, the described strategy can be used to automatically assess, validate, and visualize minimum flight turn times, which in turn improves upon the state of the art of existing scheduling and modeling systems. The data-driven method 50 when implemented as described above can enhance existing scheduling and routing of the representative aircraft 10 of FIG. 1 or other suitable vehicles, as well as optimize crew scheduling and maintenance operations, thus departing from “gut feel”/static approaches in current use. The reduced complexity and applicability of the solutions described herein thus provide these and other potential benefits and advantages, as will be readily appreciated by those skilled in the art in view of the forgoing disclosure.

The following Clauses provide example implementations of a method for determining a cost-optimal minimum turn time of a subject vehicle at a station, and other articles disclosed herein.

Clause 1: A method for determining a cost-optimal minimum turn time of a subject vehicle at a station, comprising: receiving historical data via a processor, the historical data including a set of actual past turn times of the subject vehicle at the station and available turn times of the subject vehicle at the station; creating a two-dimensional (2D) scatter plot of the historical data via the processor, wherein the 2D scatter plot is comprised of a plurality of data points; identifying an inflection point on the 2D scatter plot as a point of intersection of two straight lines on the 2D scatter plot; determining the cost-optimal minimum turn time via the processor using the inflection point; and executing a scheduling action of the subject vehicle via the processor using the cost-optimal minimum turn time.

Clause 2. The method of clause 1, further comprising performing a Hough transform on the plurality of data points via the processor to thereby derive the two straight lines.

Clause 3. The method of clause 1, further comprising deriving the two straight lines using an iterative procedure, including applying a predetermined static slope parameter and a dynamic intercept parameter.

Clause 4. The method of clause 3, wherein the predetermined static slope parameter is 0.41.

Clause 5. The method of any of clauses 1-3, wherein executing the scheduling action of the subject vehicle includes displaying the cost-optimal minimum turn time on a heatmap chart, the heatmap chart including a color-coded background indicative of a relative difference between the cost-optimal minimum turn time and an expected minimum turn time provided by a manufacturer of the subject vehicle.

Clause 6. The method of any of clauses 1-5, wherein the subject vehicle is an aircraft, and the station is an airport or a terminal thereof.

Clause 7. The method of any of clauses 1-6, wherein executing the scheduling action using the cost-optimal minimum turn time includes modeling flight delay propagation through a plurality of airports.

Clause 8. The method of any of clauses 1-7, wherein modeling the flight delay propagation through the plurality of airports includes performing a Gumbel approximation.

Clause 9. The method of any of clauses 1-8, wherein executing the scheduling action includes using the cost-optimal minimum turn time to determine a future impact on a predicted reliability level of the expected minimum turn time.

Clause 10. The method of any of clauses 1-9, wherein executing the scheduling action includes rescheduling a departure of the subject vehicle from the station.

Clause 11. A scheduling system comprising: a processor; a database on which is recorded historical data, including a set of actual turn times of a subject vehicle at a station and available turn times of the subject vehicle at the station; and instructions for determining a cost-optimal minimum turn time of the subject vehicle at the station, wherein execution of the instructions by the processor causes the processor to: retrieve the historical data from the database; create a two-dimensional (2D) scatter plot of the historical data, wherein the 2D scatter plot is comprised of a plurality of data points; identify an inflection point on the 2D scatter plot as a point of intersection of two straight lines on the 2D scatter plot; determine the cost-optimal minimum turn time using the inflection point; and execute a scheduling action of the subject vehicle using the cost-optimal minimum turn time.

Clause 12. The system of clause 11, wherein the execution of the instructions by the processor causes the processor to perform a Hough transform on the plurality of data points to thereby derive the two straight lines.

Clause 13. The system of clause 11, wherein the execution of the instructions by the processor causes the processor to derive the two straight lines using an iterative procedure, including applying a predetermined static slope parameter and a dynamic intercept parameter.

Clause 14. The system of clause 13, wherein the static slope parameter is 0.41.

Clause 15. The system of any of clauses 11-14, further comprising a display screen, wherein executing the scheduling action of the subject vehicle using the cost-optimal minimum turn time includes displaying the cost-optimal minimum turn time on a heatmap chart via the display screen, the heatmap chart having a color-coded background indicative of a relative difference between the cost-optimal minimum turn time and an expected minimum turn time of the subject vehicle at the station.

Clause 16. The system of any of clauses 11-15, wherein the subject vehicle is an aircraft, and the station is an airport or a terminal thereof.

Clause 17. The system of clause 16, wherein the scheduling action includes modeling propagation of a flight delay at the airport through a plurality of airports.

Clause 18. A method for determining a cost-optimal minimum turn time of an aircraft at an airport, comprising: receiving historical data via a processor, the historical data including a set of actual turn times at the airport and available turn times at the airport; creating a two-dimensional (2D) scatter plot of the historical data via the processor, wherein the 2D scatter plot is comprised of a plurality of data points; identifying an inflection point on the 2D scatter plot as a point of intersection of two straight lines on the 2D scatterplot, including deriving the two straight lines using an iterative procedure by applying a static slope parameter of 0.41 and a dynamic intercept parameter; determining the cost-optimal minimum turn time via the processor using the inflection point; and executing a scheduling action of the aircraft using the cost-optimal minimum turn time, including rescheduling a departure of the aircraft based on the cost-optimal minimum turn time.

Clause 19. The method of clause 18, wherein executing the scheduling action of the aircraft using the cost-optimal minimum turn time includes displaying the cost-optimal minimum turn time on a heatmap chart via a display screen, the heatmap chart having a color-coded background indicative of a relative difference between the cost-optimal minimum turn time and an expected minimum turn time provided by a manufacturer of the aircraft.

Clause 20. The method of any of clauses 18-19, wherein executing the scheduling action includes using the cost-optimal minimum turn time to schedule a crew pairing of the aircraft.

To assist and clarify the description of various embodiments, various terms are defined herein. Unless otherwise indicated, the following definitions apply throughout this specification (including the claims). Additionally, all references referred to are incorporated herein in their entirety.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

What is claimed is:

1. A method for determining a cost-optimal minimum turn time of a subject vehicle at a station, comprising:
receiving historical data via a processor, the historical data including a set of actual past turn times of the subject vehicle at the station and available turn times of the subject vehicle at the station;
creating a two-dimensional (2D) scatter plot of the historical data via the processor, wherein the 2D scatter plot is comprised of a plurality of data points;
identifying an inflection point on the 2D scatter plot as a point of intersection of two straight lines on the 2D scatter plot;
determining the cost-optimal minimum turn time via the processor using the inflection point; and
executing a scheduling action of the subject vehicle via the processor using the cost-optimal minimum turn time.

2. The method of claim 1, further comprising performing a Hough transform on the plurality of data points via the processor to thereby derive the two straight lines.

3. The method of claim 1, further comprising deriving the two straight lines using an iterative procedure, including applying a predetermined static slope parameter and a dynamic intercept parameter.

4. The method of claim 3, wherein the predetermined static slope parameter is 0.41.

5. The method of claim 1, wherein executing the scheduling action of the subject vehicle includes displaying the cost-optimal minimum turn time on a heatmap chart, the heatmap chart including a color-coded background indicative of a relative difference between the cost-optimal minimum turn time and an expected minimum turn time provided by a manufacturer of the subject vehicle.

6. The method of claim 1, the subject vehicle is an aircraft, and the station is an airport or a terminal thereof.

7. The method of claim 6, wherein executing the scheduling action using the cost-optimal minimum turn time includes modeling flight delay propagation through a plurality of airports.

8. The method of claim 7, wherein modeling the flight delay propagation through the plurality of airports includes performing a Gumbel approximation.

9. The method of claim 5, wherein executing the scheduling action includes using the cost-optimal minimum turn time to determine a future impact on a predicted reliability level of the expected minimum turn time.

10. The method of claim 1, wherein executing the scheduling action includes rescheduling a departure of the subject vehicle from the station.

11. A scheduling system comprising:
a processor;
a database on which is recorded historical data, including a set of actual turn times of a subject vehicle at a station and available turn times of the subject vehicle at the station; and
instructions for determining a cost-optimal minimum turn time of the subject vehicle at the station, wherein execution of the instructions by the processor causes the processor to:
retrieve the historical data from the database;
create a two-dimensional (2D) scatter plot of the historical data, wherein the 2D scatter plot is comprised of a plurality of data points;
identify an inflection point on the 2D scatter plot as a point of intersection of two straight lines on the 2D scatter plot;
determine the cost-optimal minimum turn time using the inflection point; and
execute a scheduling action of the subject vehicle using the cost-optimal minimum turn time.

12. The system of claim 11, wherein the execution of the instructions by the processor causes the processor to perform a Hough transform on the plurality of data points to thereby derive the two straight lines.

13. The system of claim 11, wherein the execution of the instructions by the processor causes the processor to derive the two straight lines using an iterative procedure, including applying a predetermined static slope parameter and a dynamic intercept parameter.

14. The system of claim 13, wherein the static slope parameter is 0.41.

15. The system of claim 11, further comprising a display screen, wherein executing the scheduling action of the subject vehicle using the cost-optimal minimum turn time includes displaying the cost-optimal minimum turn time on a heatmap chart via the display screen, the heatmap chart having a color-coded background indicative of a relative difference between the cost-optimal minimum turn time and an expected minimum turn time of the subject vehicle at the station.

16. The system of claim 11, the subject vehicle is an aircraft, and the station is an airport or a terminal thereof.

17. The system of claim 16, wherein the scheduling action includes modeling propagation of a flight delay at the airport through a plurality of airports.

18. A method for determining a cost-optimal minimum turn time of an aircraft at an airport, comprising:
receiving historical data via a processor, the historical data including a set of actual turn times at the airport and available turn times at the airport;
creating a two-dimensional (2D) scatter plot of the historical data via the processor, wherein the 2D scatter plot is comprised of a plurality of data points;
identifying an inflection point on the 2D scatter plot as a point of intersection of two straight lines on the 2D scatterplot, including deriving the two straight lines using an iterative procedure by applying a static slope parameter of 0.41 and a dynamic intercept parameter;
determining the cost-optimal minimum turn time via the processor using the inflection point; and
executing a scheduling action of the aircraft using the cost-optimal minimum turn time, including rescheduling a departure of the aircraft based on the cost-optimal minimum turn time.

19. The method of claim 18, wherein executing the scheduling action of the aircraft using the cost-optimal minimum turn time includes displaying the cost-optimal minimum turn time on a heatmap chart via a display screen, the heatmap chart having a color-coded background indicative of a relative difference between the cost-optimal minimum turn time and an expected minimum turn time provided by a manufacturer of the aircraft.

20. The method of claim 18, wherein executing the scheduling action includes using the cost-optimal minimum turn time to schedule a crew pairing of the aircraft.
